(19) United States
(12) Patent Application Publication
(10) Pub. No.: US 2009/0296583 A1
(43) Pub. Date: Dec. 3, 2009

(54) Systems, Methods, and Apparatus for Recording Network Events Associated with a Power Generation or Delivery System

(76) Inventor: David J. Dolezilek, Pullman, WA (US)

Correspondence Address: Schweitzer Engineering Laboratories, Inc.;Richard Edge, 2350 NE HOPKINS COURT, PULLMAN, WA, 99163-5603, US

(21) Appl. No.: 12/129,093

(22) Filed: May 29, 2008

(51) Int. Cl. H04L 12/26

(52) U.S. Cl. 370/241

(57) ABSTRACT

A network recorder adapted for use within power generation, delivery and protection systems and/or process control systems is disclosed. The network recorder itself comprises a network port coupled to a communications network utilized by a monitoring, control, automation, and protection system. A storage device stores packets that are communicated on the communications network in conjunction with other calculated or measured information. The network recorder also includes a processor that generates an event report on reception of a trigger, where a trigger can be any external event, including the operation of a relay contact, or the occurrence of a packet or sequence of packets indicating a protection operation by a power protection device within the power protection system. The generated event report includes packets that were communicated on the communications network temporally coincident with the trigger.

### FIELD OF THE INVENTION

The present invention relates generally to systems, apparatus, and methods for recording network events associated with a power generation system or a power delivery grid, and more particularly to (1) systems, apparatus, and methods for recording, on an intelligent electronic device coupled to a power generation or delivery system which includes power protection, network packets that are communicated before, during, and after an internally detected event, and (2) systems, apparatus, and methods for recording, on a network device coupled to a network associated with one or more intelligent electronic device, network packets that are communicated before, during, and after an event detected by an intelligent electronic device, and (3) methods for recording, on an intelligent electronic device coupled to a power generation or delivery system, network packets that are communicated before, during, and after an event is detected by a different intelligent electronic device.

### DESCRIPTION OF THE PRIOR ART

Power protection devices, such as relays and other intelligent electronic devices (“IEDs”), maintain a record of many protection events. For example, a relay typically includes an event recorder that records information before, during, and after a protection event. This information may include, but is not limited to, measured line current, measured line voltage, phasor information, the result of certain internal logic functions, and other protection and automation information. When a system event occurs and causes a protection or automation event operation within an IED, an event report is generated including pertinent information for a particular time period before and after the IED event operation. Appropriate personnel can access this event report at a later time and determine if the IED acted appropriately or whether troubleshooting of the device is required.

Data networking has become an important element for protecting, controlling, and automating the power grid. Prior to the use of data networking to communicate system parameters actual physical measurements had to be made for each monitored parameters. For example, for each device that needed to monitor a particular voltage, an instrument transformer and data acquisition board would be utilized. While networking has allowed for numerous advances and improvements over older, non-networked power protection systems, the networked nature of the power grid also provides an additional point of failure and attack. Indeed, network communications can even cause a power protection event, as detailed in U.S. Pat. No. 5,793,750, which is assigned to Schweitzer Engineering Laboratories, Inc., and hereby incorporated by reference in its entirety. However, network communications are not included in event reports generated by prior art power protection devices. One reason for this is that power generation and delivery systems typically did not use standard networking technologies. For example, power systems use specialized network protocols, such as MirroredBits®, a proprietary high-performance protocol used by equipment manufactured by Schweitzer Engineering Laboratories, Inc., and IEC61850, an open-standards power protection networking protocol, to communicate among themselves. In addition, while “Ethernet” may be used, certain power system specific modifications should be made. The use of non-standard networking technologies makes the use of off-the-shelf recording solutions problematic.

It is also known to examine network traffic and classify packets as being associated with a particular application. This aids in reviewing network traffic by allowing a reviewer to focus on a particular type of packet. For example, packets associated with a file transfer protocol (“FTP”) operation can be marked by a network monitor as “FTP packets.” Further, the use of a “sliding window” is also known as a mechanism whereby network traffic can be stored for a limited period of time unless an external trigger causes it to be stored indefinitely. The stored network traffic can then be examined for occurrences of interest, such as potential intrusion attempts. The article “Mnemosyne: Designing and Implementing Network Short-Term Memory,” by Giovanni Vigna and Andrew Mitchell and hereby incorporated by reference in its entirety, describes one such system. Nonetheless, while logging network communications is known in other fields, it is not presently practiced within the field of power generation and delivery, nor is it triggered by actions within IEDs rather than network traffic or coordinated among multiple IEDs.

According to the Central Intelligence Agency of the United States government, several attempts have been made by criminal elements to sabotage the power grids of various states for the purpose of extorting money or concessions. One way that security has been improved in other areas is by recording network events. While recording an event may not directly improve security, it does allow experts to review the event after the fact, identify any particular problems, and correct them with, for example, software upgrades or device replacement. In addition, network recorders are often used to troubleshoot problems with a network, such as outages and other problematic conditions, as they are occurring. Generally, a network recorder will be triggered manually, and will then stop recording on a secondary trigger, such as the amount of packets recorded, the amount of time elapsed, an additional manual trigger, etc. Selective network recorders, meaning those that record a subset of all messages are also known in the art. For example, World Intellectual Property Organization Publication WO 2005/086418, titled “DATA STORAGE AND PROCESSING SYSTEMS,” and hereby incorporated by reference in its entirety, discloses a network recorder that can “cull” certain irrelevant messages from the recorded messages, thereby lowering the time and processing power required to analyze the recorded messages. In addition, other technological areas also utilize different methods to cull inappropriate information from log files. For example, U.S. Pat. No. 6,539,341, titled “METHOD AND APPARATUS FOR LOG INFORMATION MANAGEMENT AND REPORTING,” and hereby incorporated by reference in its entirety, discloses a general logging system that allows a user to specify multiple levels of log granularity, with higher levels of granularity resulting in a greater number of log entries.

Firewalls are commonly used network protection devices. A firewall is generally placed between a protected network and any external networks, so that any packets seeking to contact a device coupled to the protected network must pass through the firewall. Generally, firewalls examine network traffic and look for problematic occurrences, such as packets from a banned address, or a stream of packets indicative of a denial-of-service attack. When a problematic occurrence is identified, the packet or packets embodying the occurrence are isolated, and not allowed to reach their intended destination device. Specifically, firewalls have developed numerous different indications of potential network problems, including those caused by intruders. Examples of firewall technology can be found in U.S. Pat. Nos. 5,623,601, 5,826,014, and 5,898,830, all of which are hereby incorporated by reference. The use of firewalls within power protection networks is also known in the art; see U.S. Pat. No. 6,751,562, hereby incorporated by reference.

### OBJECTS OF THE INVENTION

Accordingly, it is an object of this invention to provide a network recorder within an intelligent electronic device, so that network traffic surrounding an event will automatically be recorded.

Another object of this invention is to combine into the network event report recorded network traffic and traditionally recorded information which may include, but is not limited to, measured line current, measured line voltage, phasor information, the result of certain internal logic functions, and other protection and automation information.

Another object of this invention is to provide a stand alone network recorder adapted for use in power generation and delivery systems, so that network traffic surrounding an event triggered operation can be independently recorded.

Another object of this invention is to provide a method within the IEDs and the network recorder to trigger recording of network traffic surrounding an event in other IEDs or network recorders.

Another object of this invention is to provide an event report including network packets communicated temporally coincident with an event that can be reviewed after an operation to verify correct action or troubleshoot any problems relating to the operation, including any potential security vulnerabilities.

Another object of this invention is to provide evidence of a network attack on a power protection system that can be used by law enforcement to identify and apprehend malicious parties.

Other advantages of the disclosed invention will be clear to a person of ordinary skill in the art. It should be understood, however, that a system, method, or apparatus could practice the disclosed invention while not achieving all of the enumerated advantages, and that the protected invention is defined by the claims.

### SUMMARY OF THE INVENTION

The disclosed invention achieves these objectives by providing a network recorder adapted for use in a networked power generation and delivery system. The network recorder itself comprises a network port coupled to the communications network utilized by the power generation and delivery system and a storage device for storing packets that are communicated on the communications network. Further, the network recorder includes a processor that generates an event report on reception of a trigger, where a trigger can be any external event, such as, for example, the operation of a relay contact, or the occurrence of a packet or sequence of packets indicating a protection or automation operation by an IED within the power generation and delivery system.

In one embodiment, the network recorder is provided as a standalone device. In an alternative embodiment, the network recorder is integrated into an intelligent electronic device operating within the power protection system. Both embodiments may use a mechanism to trigger other IEDs or network recorders to act so that a collection of devices record in a synchronized manner.

In either embodiment, the storage device may store packets permanently, using a suitable storage solution, or it may store packets in a first-in first-out manner, i.e., a fixed amount of space is dedicated to storing packets, and, when that space becomes full, the oldest packets are overwritten. Further, the event report may include packets that are communicated on the network temporally coincident with the trigger. In particular, the event report may include packets starting with those that were stored a first time period before the occurrence of the trigger until a second time period after the occurrence of the trigger.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a network diagram of a simple power protection system as part of a larger power generation and delivery system that is protecting a single power line segment using networked intelligent electronic devices;

FIG. 2 depicts the network diagram of FIG. 1 after the occurrence of a hard fault on a protected power line segment;

FIG. 3 is an illustration of a sequence of packets, further showing where a power protection event occurred and a particular window of packets that are saved starting before the event and ending after the event;

FIG. 4 is a block diagram of a network recorder constructed in accordance with an embodiment of the disclosed invention;

FIG. 5 is a simplified block diagram illustrating the logging components of an intelligent electronic device constructed in accordance with an embodiment of the disclosed invention; and

FIG. 6 is a flowchart illustrating the high-level operation of a program used to generate event reports including network events.

### DETAILED DESCRIPTION OF THE ILLUSTRATED EMBODIMENT

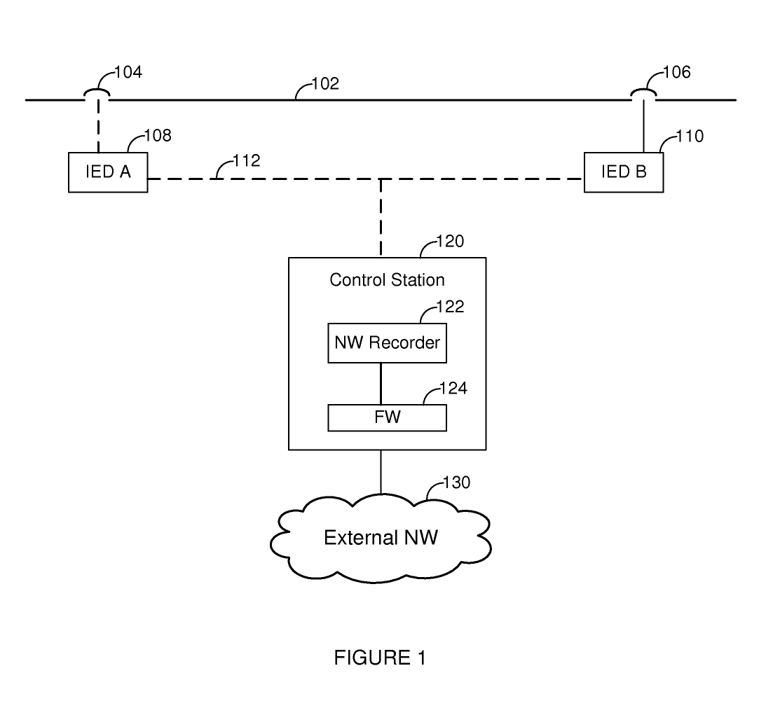

Turning to the Figures, and to FIG. 1 in particular, a simple power protection system is illustrated. In the illustrated system, a power line segment 102 is protected by a first circuit breaker 104 and a second circuit breaker 106. The operation of the circuit breakers 104, 106 can effectively isolate the power line segment 102 from the remainder of the power distribution grid (not shown). A first intelligent electronic device (“IED”) 108 is configured to monitor a portion of power line segment 102 extending from circuit breaker 104 nearly to circuit breaker 106. A second intelligent electronic device 110 is configured to monitor a portion of power line segment 102 extending from circuit breaker 106 nearly to circuit breaker 104.

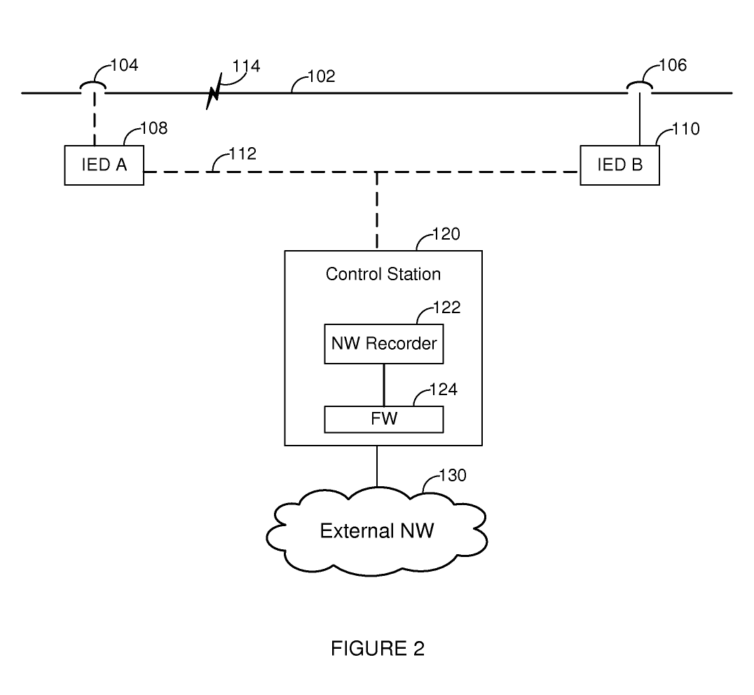

FIG. 2 shows the occurrence of a hard fault 114 on power line 102. When IED 108 detects fault 114 it will cause circuit breaker 104 to operate. Simultaneously, IED 108 will send one or more packets to IED 110 notifying it of the fault using networking medium 112. IED 110 will then cause circuit breaker 106 to operate, effectively isolating the fault 114 from the remainder of the power distribution grid. While fiber is shown as the type of networking medium, any type of networking medium could be used to implement the disclosed invention. For example, copper wire, a wireless microwave link, or any other networking medium could all be used to implement the disclosed invention.

In accordance with one embodiment of the disclosed invention, a network control station 120 is coupled to the networking medium 112. The network control station 120 includes a network recorder 122. In addition, the network control station 120 may optionally include a firewall 124 and a connection to an external network 130. Note that the firewall is not an essential element of the system, and is only present to provide security additional to that already within the different networked devices. The network recorder 122 records packets that are communicated on the network that it monitors. In FIG. 1, network recorder 122 records network packets generated by intelligent electronic devices 108 and 110, as well as any packets from external network 130 that are allowed by firewall 124. The record maintained by network recorder 122 may be permanent, which would require suitable data storage. For example, if, in a typical month, 30 megabytes of packets are communicated on the monitored network, a pair of 50 megabyte hot-swappable drives could be used, and the “full” drive could be swapped out once a month. Alternately, the record maintained by network recorder 122 could function as a first-in-first-out (“FIFO”) cache, where older packets are automatically overwritten by newer packets after a certain time has elapsed, or when additional storage is required.

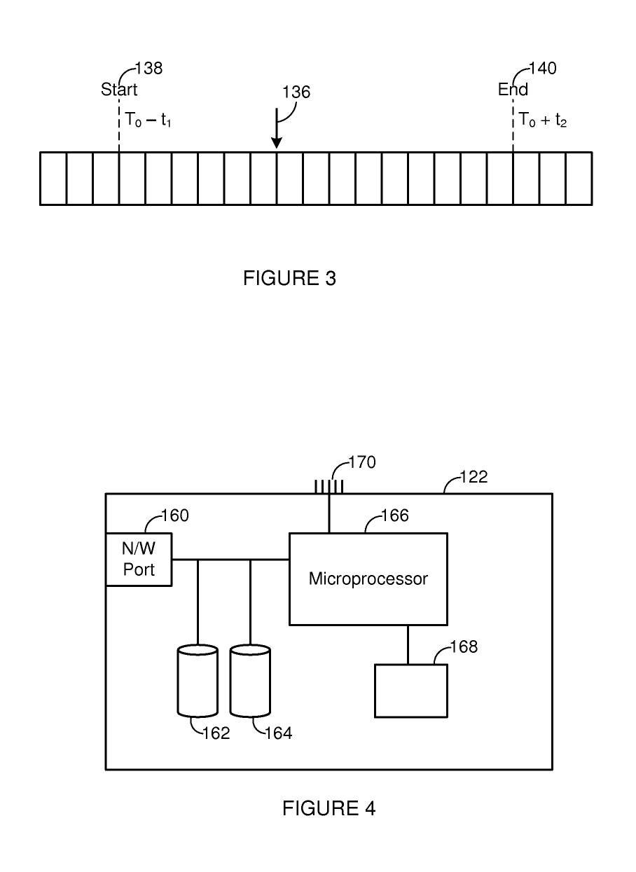

In one embodiment of the disclosed invention, the network recorder 122 is responsive to one or more triggers. A trigger is any external stimulus, and can include, without limitation, an external signal, such as a relay contact, or a particular sequence of packets, such as a sequence of packets indicating that a protection operation has occurred, a trip command sent by an IED to a breaker, recloser, switchgear, or other IED, a sequence of packets signaling the loss of communication with a particular IED, a packet indicating that a certain status bit of an IED has been set, a sequence of packets indicating the occurrence of a local or wide area power system anomaly from a local or remote source, a sequence of packets indicating an abnormality in the communications network, a packet indicating that the receiving device should generate an event report, or the reception of a packet implementing a particular network command. In this embodiment of the invention, when a trigger occurs, the network recorder will generate an event report including packets that were communicated on the monitored network for some period of time before and after the triggering event, as well as during the event. One such sequence of packets is depicted in FIG. 3. The triggering event 136 occurred at time T₀. As the network recorder 122 is constantly recording and storing packets, to build the illustrated sequence, it added the packets recorded from time T₀−t₁, denoted as identifier 138, to the event report. It continued to add packets communicated on the monitored network to the event report until time T₀+t₂, denoted as identifier 140. Each packet may be time stamped, which would require the network recorder 122 to incorporate a high precision clock, which could derive its reference from a time source, such as an IRIG-B time source. The network event report may be maintained locally or, alternatively, where a connection to an external network is present, can be transmitted to an external computer. In either case, the event report is available for later review by appropriate personnel.

As outlined above, an event report may be triggered by the network recorder 122 noting an abnormality in the communications network. Such an abnormality may include, for example, one or more packets indicating a denial of service attack is occurring, one or more improperly formatted packets, one or more packets with improper MIME headers, a long period of time without any packets being transmitted by a particular device, the failure of a device to respond to a query packet, or some other network abnormality.

FIG. 4 is a block diagram depicting a network recorder 122 constructed in accordance with an embodiment of the disclosed invention. The network recorder 122 includes a network port 160 adapted to communicate with a power systems communication network. The network port 160 could be, for example, an Ethernet port. A storage device 162 records all packets that are monitored by the network port 122. Another storage device 164 holds software implementing the network recorder for execution on processor 166. In addition, the network recorder 122 may include a high-precision clock 168, which can be used to time stamp recorded packets, and one or more relay contacts 170 that can be used as triggers.

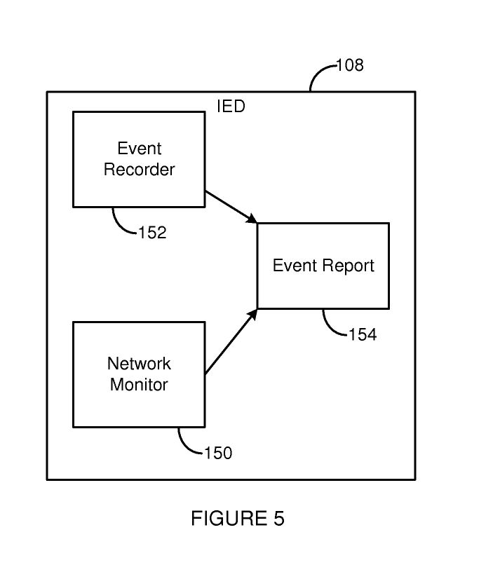

FIG. 5 shows an alternative embodiment of the disclosed invention. In this embodiment, a network monitor 150 is embedded within an intelligent electronic device 108. The network monitor could be a firmware application that is executed by a processor, field programmable gate array (“FPGA”), or similar computing device within the IED 108. In addition, the IED 108 may incorporate additional storage to store network packets. Similar to the network recorder 122 described above, when a trigger occurs, the intelligent electronic device 108 generates an event report 154. Unlike prior art event reports, however, this event report will include packets as described above, as well as any power protection events generated by the power protection event recorder 152. The inclusion of packets in the event report 154 provides a fuller description of the why a particular action was taken by the IED 108. For example, the inclusion of network events in the event report 154 will allow for the review of network based trips, such as when a different IED orders a protection event.

The embodiments of FIG. 1 and FIG. 4 can be used simultaneously in a single power protection scheme. For example, IEDs with the internal network event recorder of FIG. 4 would capture all packets, as well as other events, that surrounded power protection operations that the individual IED participated in. However, the network event recorders present within the IEDs would not capture network traffic directed to other IEDs and other network devices. A stand alone network event recorder, adapted to monitor power protection network traffic, could capture all network traffic within a particular protection system, thereby providing a more complete record if the records maintained by the individual IEDs are not sufficient to troubleshoot a particular problem.

Further, after a particular device notes the occurrence of an event or some other trigger, that device may generate one or more packets causing other devices to generate event reports, thereby guaranteeing that more complete data is available for review. For example, the network recorder 122 of FIG. 1 could, on noting an aberrant condition, generate a packet triggering IED B 110 to generate an event report. The reverse could also occur. To prevent the generation of continuous event reports, devices could include code to prevent generation of multiple event reports from the same original trigger. This would require encoding the original trigger with an identifier, and including that identifier in any trigger packets that are forwarded to other devices.

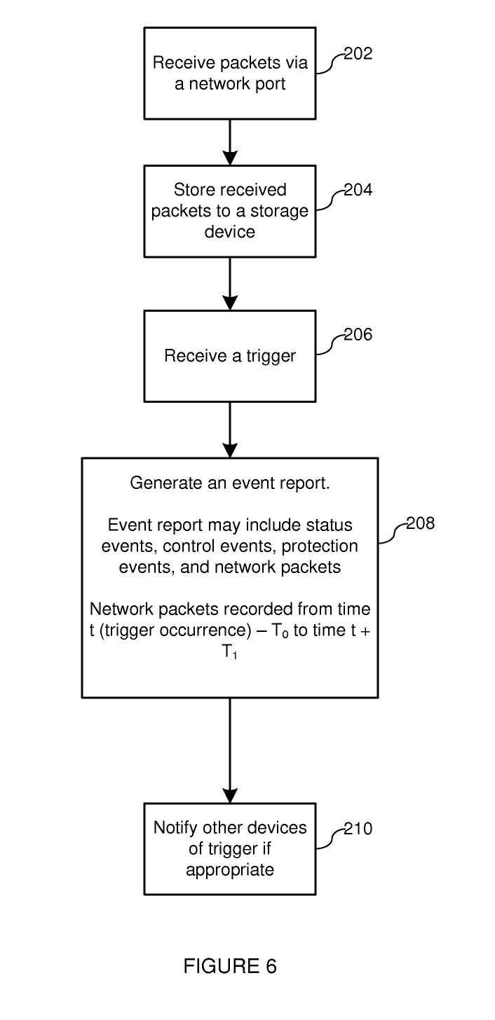

FIG. 6 shows the basic process of generating an event report including network reports. In step 202, a networked device receives packets using a network port. Those packets are stored to a storage device in step 204. The type of storage device is not important for the purposes of this invention; for example, a hard drive, USB drive, RAID array, storage array network, or any other data storage mechanism could be used to implement this step. In step 206, the networked device receives a trigger, and in step 208, an event report is generated including the stored packets. As packets are recorded continuously as described earlier, the packets placed into the event report could include a subset of packets starting some time period before the occurrence of the trigger and ending some time period after the occurrence of the trigger. Finally, if configured to trigger other devices on reception of a trigger, the device may generate one or more trigger packets and send those packets to other devices, causing the other devices to generate event reports.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A network recorder for use in a power generation and/or delivery and/or protection system including one or more intelligent electronic devices wherein each device is coupled to a communications network comprising:
i) a network port coupled to the communications network and adapted to send and receive packets;
ii) a storage device coupled to the network port for storing the packets; and
iii) a processor coupled to the network port and the storage device, wherein the processor generates an event report on recognition of a trigger, the event report including at least one of the stored packets.

2. The network recorder of claim 1 wherein the event report includes packets communicated on the communications network starting a first time period before occurrence of the trigger and ending a second time period after occurrence of the trigger.

3. The network recorder of claim 1 further comprising at least one relay contact and wherein the trigger is the operation of the relay contact.

4. The network recorder of claim 1 wherein the trigger comprises one or more packets indicating the occurrence of a protection operation by one or more of the intelligent electronic devices.

5. The network recorder of claim 1 wherein the stored packets include an oldest stored packet and wherein the storage device stores a fixed amount of packets before overwriting the oldest stored packet.

6. The network recorder of claim 1 wherein the network recorder is disposed within one of the intelligent electronic devices, and wherein the stored packets comprise only those packets sent from or received by the intelligent electronic device.

7. The network recorder of claim 1 wherein the network recorder is triggered on reception of a trigger packet from an external device.

8. The network recorder of claim 1 wherein the processor is configured to generate a trigger packet upon recognition of the trigger.

9. The network recorder of claim 8 wherein the processor is further configured to cause the network port to communicate the trigger packet upon recognition of the trigger.

10. The network recorder of claim 1 wherein the trigger comprises an abnormality detected on the communications network.

11. A method for use in a power generation, delivery, or protection system for generating an event report describing events occurring within said system including network events, the method comprising the steps of:
i) receiving packets using a network port;
ii) storing at least some of the received packets to a storage device;
iii) receiving a trigger; and
iv) generating an event report containing at least one of the stored packets.

12. The method of claim 11 wherein the trigger is reception of a trigger packet.

13. The method of claim 11 further comprising the step of generating a trigger packet on reception of said trigger.

14. The method of claim 13 further comprising the step of transmitting said trigger packet to an external device.

15. The method of claim 11 wherein the step of generating the event report results in an event report containing packets communicated on the communications network starting a first time period before reception of the trigger and ending a second time period after reception of the trigger.
